(19) United States
(12) Patent Application Publication
(10) Pub. No.: US 2018/0204242 A1
(43) Pub. Date: Jul. 19, 2018

(54) ELECTRONIC APPARATUS AND CONTROLLING METHOD THEREOF

(71) Applicant: Samsung Electronics Co., Ltd., Suwon-si (KR)

(72) Inventors: Sung-jin CHOI, Yongin-si (KR); Sung-hyun PARK, Seoul (KR); Hyun-sik YOON, Seoul (KR)

(21) Appl. No.: 15/870,128

(22) Filed: Jan. 12, 2018

(30) Foreign Application Priority Data
Jan. 13, 2017 (KR) 10-2017-0006092

(51) Int. Cl. G06Q 30/02; G06F 3/14; G06Q 30/06; G06Q 20/10; H04W 4/80; H04L 9/06; H04L 29/08

(52) U.S. Cl. CPC G06Q 30/0241; G06F 3/1454; G06Q 30/06; H04L 2209/56; H04W 4/80; H04L 9/0637; H04L 67/104; G06Q 20/10

(57) ABSTRACT

An electronic apparatus and a controlling method thereof are provided. The controlling method of an electronic apparatus includes receiving device information related to external display devices from a plurality of external terminals through a wireless network, wherein each external display device is controlled by a corresponding external terminal, identifying a first external display device among the external display devices based on the device information and reputation information associated with each of the plurality of external terminals, and transmitting advertisement information to a first external terminal associated with the first external display.

### CROSS-REFERENCE TO RELATED APPLICATION(S)

This application claims the benefit under 35 U.S.C. § 119(a) of a Korean patent application filed on Jan. 13, 2017 in the Korean Intellectual Property Office and assigned Serial number 10-2017-0006092, the entire disclosure of which is hereby incorporated by reference.

### TECHNICAL FIELD

The present disclosure relates to an electronic apparatus and a controlling method thereof. More particularly, the present disclosure relates to an electronic apparatus for providing advertisement using a screen of an external display device, and a controlling method thereof.

### BACKGROUND

Cases in which companies, as well as individuals, provide advertisement to unspecified persons through a large display panel at a place having a large floating population are increased.

Further, a demand on an economic activity by sharing information on electronic devices connected to each other through a network such as Internet to buy and sell inter-device resources between users using the electronic devices is increased.

Therefore, a shared economic activity by sharing a screen between the electronic devices connected to each other through the network to provide the advertisement may be increased.

In general, a method for providing an advertisement by sharing the screen requires a separate server other than the electronic devices connected to each other through the network. Therefore, a server based advertisement management system incurs maintenance cost by maintaining a central server.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an electronic apparatus for providing an advertisement to a screen of an external display device using a block chain method in a wireless network communication network without using a server, and a controlling method thereof.

In particular, a distributed advertisement management system that does not use the central server is disclosed. Such an advertisement management system increases transaction stability between the users and increases security by distributing information.

In accordance with an aspect of the present disclosure, a controlling method of an electronic apparatus is provided. The method includes receiving device information related to external display devices from a plurality of external terminals through a wireless network, wherein each external display device is controlled by a corresponding external terminal, identifying a first external display device among the external display devices based on the device information and reputation information associated with each of the plurality of external terminals, and transmitting advertisement information to a first external terminal associated with the first external display.

In accordance with another aspect of the present disclosure, an electronic apparatus is provided. The electronic device includes a transceiver configured to communicate through a wireless network, a memory, and a processor configured to control the transceiver to receive device information related to external display devices from a plurality of external terminals, wherein each external display device is controlled by a corresponding external terminal, identify a first external display device among the external display devices based on the device information and reputation information associated with each of the plurality of external terminals, and control the transceiver to transmit advertisement information to a first external terminal associated with the first external display.

In accordance with another aspect of the present disclosure, an external terminal in a block chain based distributed open advertisement market system is provided. The external terminal includes a transceiver configured to communicate through a wireless network, a memory, and a processor configured to control the transceiver to receive advertisement information, identify a reputation of an electronic apparatus based on the advertisement information, and control an external display device to play an advertisement based on the reputation of the electronic apparatus.

In accordance with another aspect of the present disclosure, an electronic apparatus and controlling method thereof are provided. The electronic apparatus and controlling method thereof include a safe and transparent transaction between the devices connected to each other through the wireless network by using the block chain technology.

Further, since the electronic apparatus and the controlling method thereof described above directly transact the advertisement between the devices connected to each other through the wireless network without using the server, it is possible to reduce server operation cost and overhead for server management.

In accordance with another aspect of the present disclosure, an electronic apparatus and controlling method thereof are provided. The electronic apparatus and controlling method thereof include a transparent and safe transaction based on reputations for the respective devices identified by participants participating in the transaction, by storing transactional histories between the electronic devices using the advertisement sharing system in the block chain, which is a distributed database, without forging or falsifying the transactional histories.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating a block chain based distributed open advertisement market system according to an embodiment of the present disclosure;

FIG. 2 is a flowchart illustrating a method of an electronic apparatus according to an embodiment of the present disclosure;

FIG. 3 is a flowchart illustrating a method of an external terminal according to an embodiment of the present disclosure;

FIG. 4 is a flowchart illustrating a method of a display device according to an embodiment of the present disclosure;

FIG. 5 is a sequence diagram illustrating a method of a block chain based distributed open advertisement market system according to an embodiment of the present disclosure;

FIGS. 6A and 6B are block diagrams configuring a block chain based distributed open advertisement market system according to various embodiments of the present disclosure;

FIG. 7 is a block diagram of an electronic apparatus configuring a block chain based distributed open advertisement market system according to an embodiment of the present disclosure;

FIG. 8 is a block diagram of an external terminal configuring a block chain based distributed open advertisement market system according to an embodiment of the present disclosure;

FIG. 9 is a block diagram of a display device configuring a block chain based distributed open advertisement market system according to an embodiment of the present disclosure; and

FIG. 10 is a block diagram of an input device connected to a display device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

A term ‘and/or’ includes a combination of a plurality of related described items or any one of the plurality of related described items.

The terms used in the present disclosure are used to describe various embodiments and are not intended to limit and/or to restrict the present disclosure. As used herein, the singular forms are intended to include plural forms as well, unless the context clearly indicates otherwise.

In the present disclosure, it will be understood that the terms “comprises” or “have” specify the presence of stated features, numerals, operations, components, parts, or a combination thereof, but do not preclude the presence or addition of one or more other features, numerals, operations, components, parts, or a combination thereof. Like reference numerals present in the respective drawings denote members that perform substantially the same function.

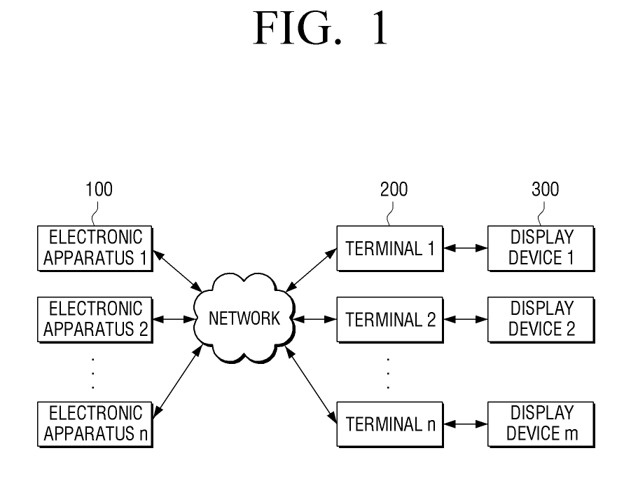

FIG. 1 is a diagram illustrating a block chain based distributed open advertisement market system according to an embodiment of the present disclosure.

Referring to FIG. 1, a system 10 includes a plurality of electronic apparatuses 100 and a plurality of terminals 200 which are connected to each other through a network, and a plurality of display devices 300 controlled by each of the plurality of terminals 200.

In the system 10, the plurality of terminals 200 and the plurality of electronic apparatuses 100 which are connected to each other through the network, and the plurality of display devices 300 may directly upload and/or download advertisement information to each other through a distributed network without using a relay such as a central server.

The network may be a wired and/or wireless network. Specifically, the network according to an embodiment of the present disclosure may be a peer to peer (P2P) network through which the plurality of electronic apparatuses 100, the plurality of terminals 200, and the plurality of display devices 300 may directly communicate data without using the server, but is not limited thereto.

Transactional histories between the electronic apparatuses 100, the terminals 200, and the display devices 300 may be stored in a block chain, which is a P2P network based distributed database.

Further, according to an embodiment of the present disclosure, the electronic apparatuses 100, the terminals 200, and the display devices 300 may evaluate reputations for transactions using the transactional histories stored in the block chain and store the evaluated reputations in the block chain.

For example, the transactions may include providing, by the electronic apparatus 100, advertisement information to the external terminal 200, and playing, by the external terminal 200, an advertisement on a screen of the display device 300 at a time slot desired by the electronic apparatus 100. Further, the transactions may include paying, by the electronic apparatus 100, the cost of using the screen of the display device 300 to the external terminal 200.

For example, the reputations may be values obtained by identifying, by the electronic apparatuses 100, the terminals 200, and the display devices 300 in the system 10, whether or not conditions (e.g., contract conditions) requested by the respective electronic apparatuses 100, the terminals 200, and the display devices 300 are performed based on the information stored in the block chain and evaluating reputation values based on whether or not the contract conditions are performed. However, the above-mentioned examples are merely various embodiments for describing the present disclosure, and the present disclosure is not limited thereto.

The block chain may be a collection in which data blocks generated by the transactions are connected in series with each other in a chain form. For example, the block chain stores ledger data in units of block to prevent a forgery using a hash algorithm and configures the block into a linked list to include a hash value of a previous block in a next block, thereby making it impossible to forge only a medium single block.

For example, a distributed electronic ledger that records a transaction process of encrypted money of virtual money used in the transactions in the system 10 may use the block chain. That is, the final transactional history between the users for a given time may be stored in the blocks of the block chain. All of the user terminals using the encrypted money transaction, the advertisement, and the transaction between screen information of the display device 300 may each have a block chain copy. Further, the transactional histories between the respective terminals in the system 10 may be stored in the block chain and may be published to all of the user terminals. For example, the transactional histories having consensus of more than half of the users are recognized as verified transactions, and the verified transactional histories may be grouped into the block to be stored. In this case, a newly formed block is added to the tail of a previous block chain.

That is, the block chain continuously encrypts the previous block and the next block and recognizes only data having the consensus of more than half of the users as verified data. Therefore, it is impossible to forge and falsify the contents recorded in the transaction in the distributed database using the block chain.

According to an embodiment of the present disclosure, in order to perform the transactions between the electronic apparatuses 100, the terminals 200, and the display devices 300 through the distributed network in the system 10, the respective electronic apparatuses 100, the terminals 200, and the display devices 300 may download an application providing the block chain based open advertisement market from the external server and execute the application in the respective terminals.

In the present disclosure, for convenience of explanation, the plurality of terminals 200 will be described as an external terminal 200, the plurality of electronic apparatuses 100 will be described as an electronic apparatus 100, and the plurality of display devices 300 will be described as a display device 300. In this case, the external terminal 200, the electronic apparatus 100, and the display device 300 may be devices participating in performing the transactions between the devices by providing advertisement information and screen information by the system 10.

The external terminal 200, the electronic apparatus 100, and the display device 300 may store advertisement information, screen information, transactional history information, cost payment history information, transaction execution history information, transaction breach history information, and reputation information provided from the respective devices in memories of the respective devices using the block chain method.

The advertisement information may be information related to an advertisement provided from the electronic apparatus 100. For example, the advertisement information may be a variety of information related to the advertisement provided from a general advertiser, such as a kind of advertisement, an advertisement playback time, an advertisement target, price information on advertisement playback, screen information needed for advertisement playback, and the like. The screen information may be information related to the screen of the display device 300. For example, the screen information may be image quality, a size, and a position of the screen, usage cost according to a usage time of the screen, a kind of advertisement allowed by the screen, and the like, but is not limited thereto.

The electronic apparatus 100 may transmit the advertisement intended to be displayed on the screen of the display device 300 to the external terminal 200 and/or the display device 300. The electronic apparatus 100 may be various electronic apparatuses such as a mobile phone, a tablet personal computer (PC), a smartphone, a wearable device, and the like. Further, the electronic apparatus 100 may be an apparatus of an advertiser who directly manufactures the advertisement.

The external terminal 200 may receive information related to the advertisement from the electronic apparatus 100. The information related to the advertisement may be a time at which the advertisement is played in the display device 300, the contents of the advertisement, and the like, but is not limited thereto. The external terminal 200 may also remotely control the display device 300. The external terminal 200 may be various electronic apparatuses such as a mobile phone, a tablet PC, a smartphone, a wearable device, and the like, but is not limited thereto.

The display device 300 may display the advertisement information received from the electronic apparatus 100 on the screen of the display device 300. The display device 300 may include various types of displays such as an outdoor billboard, a video wall of a type of a large format display (LFD), a single screen, and the like, but is not limited thereto.

In the present disclosure, the advertisement may include various contents such as a video, an image, a text, and the like. Further, the advertisement may be the contents broadcasted through a broadcasting medium and may be the contents which are streamed in real time, but is not limited thereto.

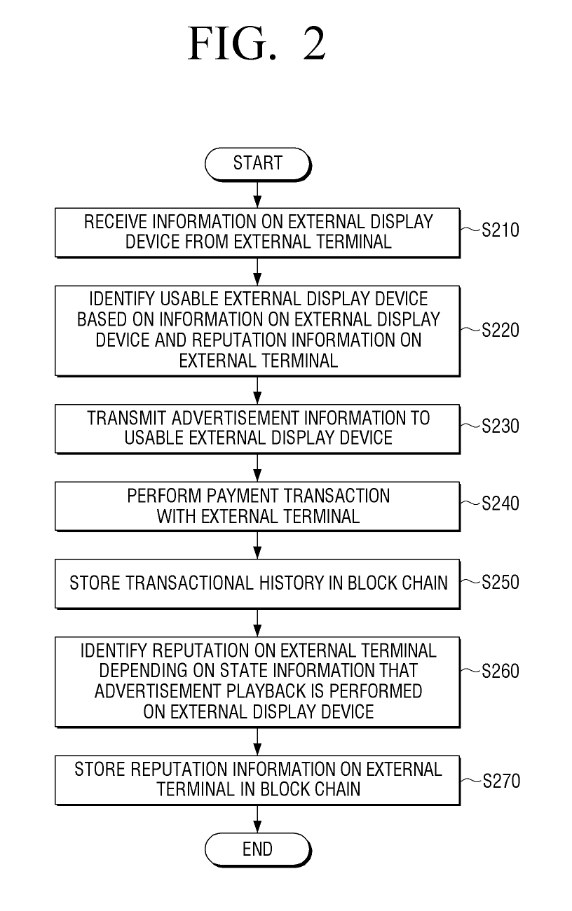

FIG. 2 is a flowchart illustrating a method of an electronic apparatus according to an embodiment of the present disclosure.

Referring to FIG. 2, in operation S210, the electronic apparatus 100 may receive information on the external display device 300 from the external terminal 200.

The electronic apparatus 100 may receive the information on the external display devices 300 controlled by the respective external terminals 200 from the plurality of external terminals 200 connected to each other through the wireless network, for example, the P2P network.

For example, the information on the external display devices 300 may be a variety of information such as position information of the respective external display devices 300, a size and pixel information of the screen, a kind of screen, a screen available time, a kind of transaction, price information according to a screen usage, and the like. For example, the position information of the screen may be provided in real time using a global positioning system (GPS), but is not limited thereto. The kind of screen may be a kind of display such as a LFD, a high-definition display, or the like.

The kind of transaction may include a purpose of the advertisement providing the screen of the external display device 300 as for the advertisement, kinds of advertisements which may be accommodated, and the like. For example, the kind of transaction may be variously classified into an advertisement for babies, an advertisement for children, an alcoholic advertisement, a travel advertisement, and the like. The above-mentioned examples are merely various embodiments for describing the present disclosure, and the present disclosure is not limited thereto.

In this case, the information on the respective external display devices 300 may be set by the external terminals 200 controlling the respective external display devices 300. In this case, the information on the external display devices 300 which is set by the external terminals 200 may be contract conditions that the external terminals 200 provide to the electronic apparatuses 100 requesting the advertisement information.

In operation S220, the electronic apparatuses 100 may identify usable external display devices 300 based on information on the external display devices 300 and reputation information of the external terminals 200.

The reputation information of the respective external terminals 200 is information identified by the plurality of external terminals 200 connected to each other through the wireless network, and may be identified depending on whether or not the advertisement playback is performed in the external display devices 300 controlled by the respective external terminals 200. Further, the electronic apparatuses 100 may identify the reputations on the external display devices 300 depending on whether or not the advertisement playback is performed by the external display devices 300.

In this case, the reputation information of different external terminals 200 evaluated by the respective external terminals 200 may be stored in the memories of the respective external terminals 200 in a block chain way. In a case in which the electronic apparatus 100 controls the external display device 300, the electronic apparatus 100 may be one external terminal 200. Further, the external terminal 200 that transmits the advertisement information to another external terminal 200 among the plurality of external terminals 200 may be the electronic apparatus 100.

For example, in a case in which the advertisement information transmitted by the electronic apparatuses 100 is played in the external display devices 300 controlled by the external terminals 200 according to the contract requested by the electronic apparatuses 100, the reputation information of the external terminals 200 and the external display devices 300 may have a value of 10. On the other hand, in a case in which the advertisement information transmitted by the electronic apparatuses 100 is played in the external display devices 300 controlled by the external terminals 200 within a designated time, the reputation information of the external terminals 200 and the external display devices 300 may have a value smaller than 10.

For example, the playback time of the advertisement requested by the electronic apparatuses 100 may be 15 seconds, and a playback time of the advertisement played by the external display devices 300 may be 10 seconds. In this case, the electronic apparatuses 100 may identify the reputations of the external terminals 200 and the external display devices 300 as a value of 7. Further, in a case in which the advertisement information transmitted by the electronic apparatuses 100 is not played in the display devices 300, the reputation information of the external terminals 200 and the external display devices 300 may have a value of 0.

Therefore, the plurality of devices participating in performing an open advertisement contract on the P2P network may identify the reputation information on the respective devices depending on whether or not the respective devices perform the contract. Further, the reputation information of the respective devices may be stored by the block chain. Therefore, the electronic apparatuses 100 may identify the external display devices 300 which are usable by the electronic apparatuses 100 using the reputation information of the respective external terminals stored in the block chain, which is the distributed database.

Further, the electronic apparatuses 100 may identify at least one external display device 300 which is positioned within a designated range from the electronic apparatuses 100 using near field communication such as Bluetooth low energy (BLE), or the like.

In this case, the electronic apparatuses 100 may identify the usable external display devices 300 using information on the electronic apparatuses 100 and the external display devices 300 which are positioned within the designated range, the reputation information of the external display devices 300, and the reputation information of the external terminals 200 controlling the external display devices 300.

The electronic apparatuses 100 may provide a list for the usable external display devices 300, and may provide a selectable user interface (UI). The electronic apparatuses 100 may provide the information on the usable external display devices 300 to various UIs.

In operation S230, the electronic apparatuses 100 may transmit the advertisement information to at least one usable external display device 300 based on the information of the external display devices 300.

For example, the advertisement information may include a kind of advertisement, an advertisement playback time, a payment contract condition according to the advertisement playback, and a transactional history. The transactional history may include a payment history for the usage of the external display device 300 by the electronic apparatus 100. In this case, the payment history may include using the screen of at least one external display device 300 of the plurality of external display devices 300 by the electronic apparatuses 100.

In operation S240, the electronic apparatus 100 may select the usable external display device 300, and may perform a payment transaction with the external terminal 200 controlling the selected external display device 300.

The electronic apparatus 100 and the external terminal 200 may perform the payment transaction with each other using a block chain based digital coin payment method.

The electronic apparatus 100, the external terminal 200, and the external display device 300 may use a method of uploading and downloading files from the P2P network. Therefore, the electronic apparatus 100 may upload the advertisement information to the external display device 300, the external terminal 200 may download the advertisement information, and the external display device may upload and/or download the advertisement information.

In operation S250, the electronic apparatus 100 may store the payment transaction history with the external terminal 200 in the memory of the electronic apparatus 100 using the block chain method.

In operation S260, the electronic apparatus 100 may identify the reputations on the external terminal 200 and the external display device 300 depending on state information in which the advertisement playback is performed by the external display device 300.

The external display device 300 may store an advertisement playback performance history in the screen of the external display device 300 in the memory of the external display device 300 using the block chain method.

In operation S270, the electronic apparatus 100 may store the reputation information on the external terminal 200 and the external display device 300 in the memory of the electronic apparatus 100 using the block chain method. Therefore, as described in operation S220, the electronic apparatus 100 may identify and select the usable external display devices 300 using the reputation information of the respective devices stored in the block chain of the plurality of devices participating in the transaction in the open advertisement target market system.

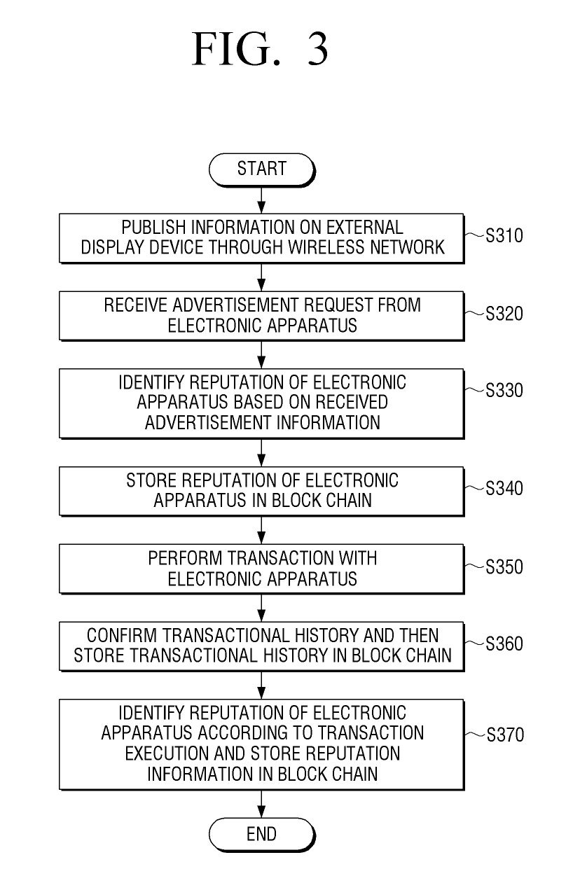

FIG. 3 is a flowchart illustrating a method of an external terminal according to an embodiment of the present disclosure.

Referring to FIG. 3, in operation S310, the external terminal 200 may provide information on the external display device 300 to the electronic apparatus 100 through the wireless network. The information on the external display device 300 refers to operation S210 of FIG. 2.

In operation S320, the external terminal 200 may receive an advertisement request from the electronic apparatus 100.

The advertisement request received from the electronic apparatus 100 may include the advertisement information. The advertisement information refers to operation S230 of FIG. 2.

In operation S330, the external terminal 200 may identify a reputation of the electronic apparatus 100 based on the advertisement information received from the electronic apparatus 100.

The external terminal 200 may identify the reputation of the electronic apparatus 100 as another value depending on whether or not the received advertisement information includes appropriate information.

For example, in a case in which the advertisement information includes erroneous information such as including illegal contents, including information harmful to a specific group, or the like, the external terminal 200 may assign a penalty to the reputation of the electronic apparatus 100 and may assign a reputation value as a minus. As another example, the external terminal 200 may also assign an incentive to the electronic apparatus 100 according to the advertisement information of the electronic apparatus 100 to thereby increase the reputation value.

In operation S340, the external terminal 200 may store the reputation of the electronic apparatus 100 in the memory of the external terminal 200 using the block chain method.

In operation S350, in a case in which the external terminal 200 grants the advertisement information requested by the electronic apparatus 100, the external terminal 200 may perform a transaction with the electronic apparatus 100.

Further, the external terminal 200 may perform the payment transaction with the electronic apparatus 100 using a block chain based digital coin payment method.

In operation S360, the external terminal 200 may confirm the transactional history with the electronic apparatus 100 and then store the transactional history in the memory of the external terminal 200 using the block chain method.

In operation S370, the external terminal 200 may identify the reputation of the electronic apparatus 100 depending on a transaction execution with the electronic apparatus 100 and store the identified reputation in the memory of the external terminal 200 using the block chain method.

For example, in a case in which a payment for the transaction using the external display device 300 is completed from the electronic apparatus 100, the external terminal 200 may identify the reputation of the electronic apparatus 100 as a value of 10. For example, in a case in which the payment for the transaction using the external display device 300 is completed by 70% of a transaction price from the electronic apparatus 100, the external terminal 200 may identify the reputation of the electronic apparatus 100 as a value of 7. Further, in a case in which the payment for the transaction using the external display device 300 is completed by 50% or less of the transaction price from the electronic apparatus 100, the external terminal 200 may identify the reputation of the electronic apparatus 100 as a value of 3. However, the above-mentioned examples are merely various embodiments for describing the present disclosure, and the present disclosure is not limited thereto.

Further, the external terminal 200 may control the external display device 300 to change and play a playback state of the advertisement transmitted by the electronic apparatus 100 on the external display device 300 depending on the reputation of the electronic apparatus 100.

For example, in a case in which the payment from the electronic apparatus 100 is not executed, the external terminal 200 may control the external display device 300 so as not to play the advertisement information requested by the electronic apparatus 100 in the external display device 300.

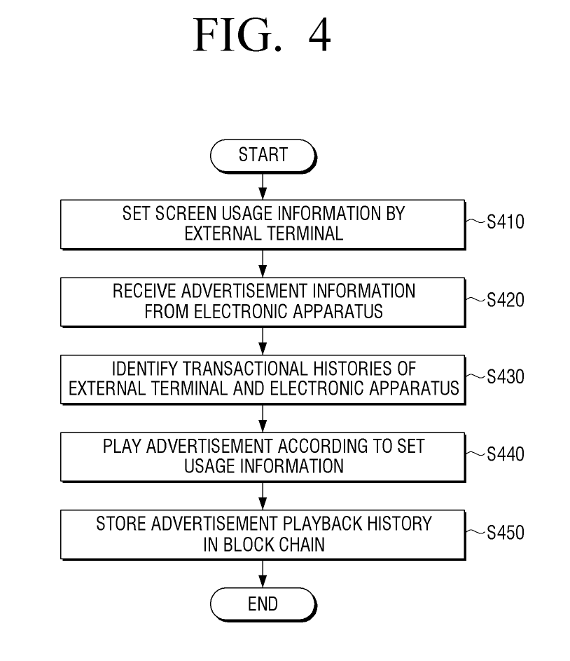

FIG. 4 is a flowchart illustrating a method of a display device according to an embodiment of the present disclosure.

Referring to FIG. 4, in operation S410, the display device 300 may have screen or display usage information which is set by the external terminal 200.

For example, the screen or display usage information may be a variety of information such as the screen available time, the kind of transaction, the price information according to the screen usage, and the like as described above in operation S210 of FIG. 2, but is merely an embodiment for describing the present disclosure and is not limited thereto.

Further, as described above in operation S370 of FIG. 3, the screen usage information may include whether or not the external terminal 200 performs the payment of the electronic apparatus 100 and the playback state change of the advertisement depending on the reputation information.

In operation S420, the display device 300 may receive advertisement information from the electronic apparatus 100. The advertisement information refers to operation S230 of FIG. 2.

In operation S430, the display device 300 may identify the transactional histories of the external terminal 200 and the electronic apparatus 100. The display device 300 may identify the transactional histories by confirming payment histories of the external terminal 200 and the electronic apparatus 100 which are stored in the block chain, which is the P2P based distributed database described above in FIG. 1.

In operation S440, the display device 300 may play the advertisement information transmitted by the electronic apparatus 100 depending on the screen usage information set by the external terminal 200.

In operation S450, the display device 300 may store an advertisement playback history in the screen in the memory of the display device 300 using the block chain method.

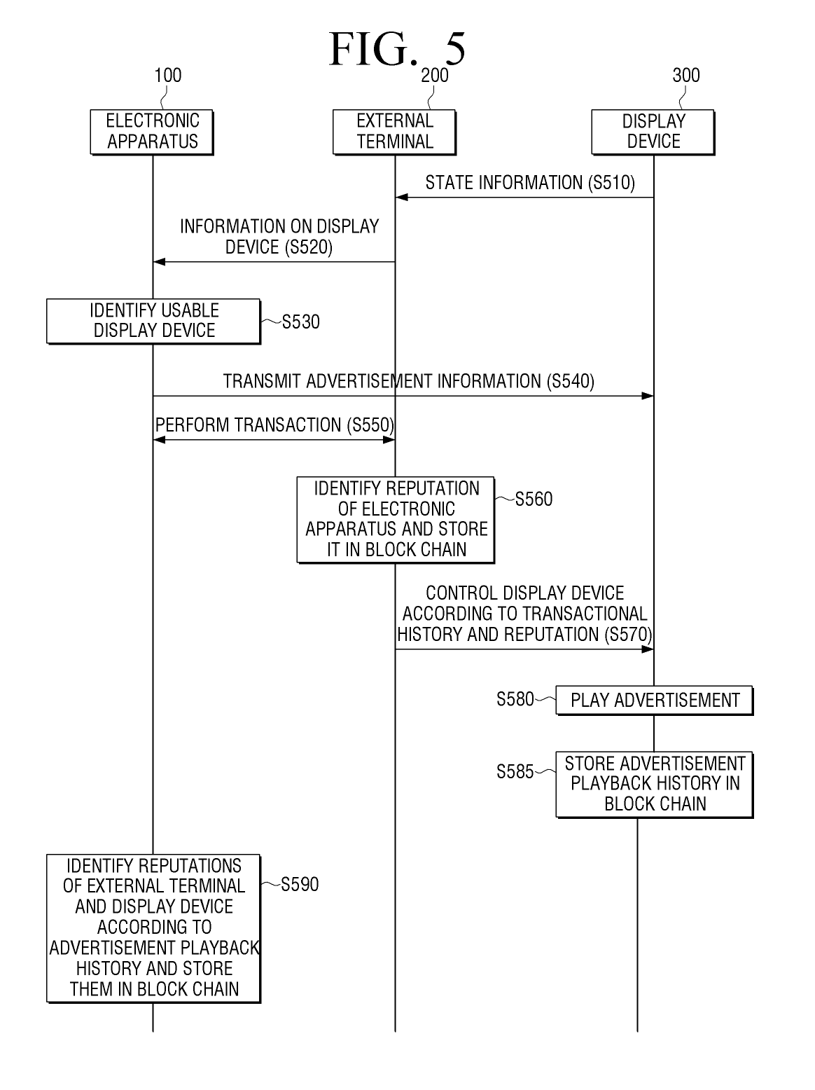

FIG. 5 is a sequence diagram illustrating a method of a block chain based distributed open advertisement market system according to an embodiment of the present disclosure.

Referring to FIG. 5, in operation S510, the display device 300 may transmit screen usage state information of the display device 300 to the external terminal 200. For example, the screen usage state information may be state information in which the screen of the display device 300 is used by other electronic apparatuses. In a case in which the screen of the display device 300 displays the advertisement of other electronic apparatuses, the display device 300 may transmit state information such as a time at which the screen usage starts and a time at which the screen usage terminates to the external terminal 200.

In operation S520, the external terminal 200 may provide information on the display device 300 to the electronic apparatus 100. The information on the display device 300 may be a variety of information such as position information of the display device 300, a size and pixel information of the screen, a kind of screen, a screen available time, a kind of transaction, price information according to a screen usage, and the like. For example, the position information of the screen may be provided in real time using a GPS, but is not limited thereto. The kind of screen may be a kind of display such as a LFD, a high-definition display, or the like.

The kind of transaction may include a purpose of the advertisement providing the screen of the external display device 300 as for the advertisement, kinds of advertisements which may be accommodated, and the like. For example, the kind of transaction may be variously classified into an advertisement for babies, an advertisement for children, an alcoholic advertisement, a travel advertisement, and the like. The above-mentioned examples are merely various embodiments for describing the present disclosure, and the present disclosure is not limited thereto.

In this case, the kind of transaction, the screen available time, the price information according to the screen usage, and the like among the information on the display device 300 may be set by the external terminal 200.

In operation S530, the electronic apparatus 100 may identify a usable display device 300.

The electronic apparatus 100 may identify the usable display device 300 based on the information on the display device 300 provided from the external terminal 200.

For example, the electronic apparatus 100 may identify the usable display device 300 based on the reputation information of the external terminal 200 evaluated by other external terminals on the network. Further, the electronic apparatus 100 may identify the display device 300 matched to the advertisement information that the electronic apparatus 100 intends to transmit the advertisement among the information on the display device 300 as the usable display device 300.

In a case in which a plurality of display devices 300 are matched to the advertisement information, the electronic apparatus 100 may identify the usable display device 300 using the reputation information of the respective external terminal 200 controlling the plurality of display devices 300. For example, the electronic apparatus 100 may identify the display device 300 controlled by the external terminal 200 having the best reputation information among the plurality of display devices 300 as the usable display device 300. Further, in a case in which the reputation information of the external terminal 200 controlling the display device 300 matched to the advertisement information is a predetermined reputation value or less, the electronic apparatus 100 may not select the usable display device 300.

The reputation information on the external terminal 200 and the display device 300 may be identified by the devices participating in the block chain based open advertisement market system 10 and stored in the respective devices by the block chain method, as described above in FIG. 1. In this case, the devices may include the external terminal 200 controlling the display device 300, and the electronic apparatus 100 providing the advertisement to the display device 300. The above-mentioned example is merely an embodiment for describing the present disclosure, and the electronic apparatus 100 may identify the usable display device 300 by various methods using the reputation information of the external terminal 200 and the display device 300.

In operation S540, the electronic apparatus 100 may transmit the advertisement information to the display device 300. The electronic apparatus 100 may transmit the advertisement information to be played to the usable display device 300. The electronic apparatus 100 and the display device 300 may transmit and receive the advertisement information using a file uploading and downloading method in the P2P network. The advertisement information refers to operation S230 of FIG. 2.

As described above in operation S510, the external terminal 200 may continue to receive state information of the display device 300 from the display device 300. Therefore, in a case in which the display device 300 receives the advertisement information from the electronic apparatus 100, the external terminal 200 may receive updated state information of the display device 300 from the display device 300.

In operation S550, the electronic apparatus 100 may perform a transaction with the external terminal 200. The transaction may be a payment transaction between the advertisement information provided by the electronic apparatus 100 and the usage of the screen of the display device 300 controlled by the external terminal 200.

The advertisement information provided by the electronic apparatus 100 may be a contract condition provided by the electronic apparatus 100, and information related to the display device 300 provided by the external terminal 200 may be a contract condition provided by the external terminal 200.

Therefore, the electronic apparatus 100 may pay the cost for using the screen of the display device 300 to the external terminal 200 according to the contract condition, and the external terminal 200 may provide the screen of the display device 300 to the electronic apparatus 100 according to the contract condition.

In this case, the electronic apparatus 100 may pay the cost for using the screen of the display device 300 to the external terminal 200 using the digital coin using the block chain method, but is not limited thereto.

The electronic apparatus 100 may store the payment history in the memory of the electronic apparatus 100 using the block chain method.

In operation S560, the external terminal 200 may identify a reputation of the electronic apparatus 100 and store the reputation in the memory of the external terminal 200 using the block chain method.

The external terminal 200 may identify the reputation of the electronic apparatus 100 based on the payment history of the electronic apparatus 100. For example, the external terminal 200 may identify the reputation of the electronic apparatus 100 depending on whether or not the electronic apparatus 100 pays the cost for the screen usage of the display device 300. For example, in a case in which the cost payment from the electronic apparatus 100 is completed, the external terminal 200 may assign the reputation of the electronic apparatus 100 as 10, and in a case in which the cost payment is not completed, the external terminal 200 may assign the reputation of the electronic apparatus 100 as 0.

Further, the external terminal 200 may also identify the reputation of the electronic apparatus 100 based on the advertisement information provided by the electronic apparatus 100. For example, in a case in which information included in the advertisement information is not suitable, or only a portion of the advertisement information is provided, the eternal terminal 200 may apply a penalty to the reputation of the electronic apparatus 100 and make the reputation value minus.

However, the above-mentioned examples are merely various embodiments for describing the present disclosure, and the present disclosure is not limited thereto, and the reputation of the electronic apparatus 100 may be digitized by various methods.

In operation S570, the external terminal 200 may control the display device 300 according to the transactional history and the reputation of the electronic apparatus 100.

In a case in which the electronic apparatus 100 does not execute the payment, the external terminal 200 may control the display device 300 so as not to play the advertisement information transmitted by the electronic apparatus 100 on the screen of the display device 300.

Further, in a case in which the electronic apparatus 100 partially executes the payment, the external terminal 200 may control the display device 300 to play the advertisement information transmitted by the electronic apparatus 100 on the screen of the display device 300 for a time according to the cost paid by the electronic apparatus 100.

Further, in a case in which the reputation information of the electronic apparatus 100 is a predetermined value or less, the external terminal 200 may control the display device 300 so as not to play the advertisement information transmitted by the electronic apparatus 100 on the screen of the display device 300. A method for controlling, by the external terminal 200, the display device 300 according to the predetermined value of the reputation information of the electronic apparatus 100 may be implemented to be variously modified.

In operation S580, the display device 300 may play the advertisement information transmitted by the electronic apparatus 100 on the screen of the display device 300 according to a control of the external terminal 200.

In operation S585, the display device 300 may store an advertisement playback history in which the advertisement transmitted by the electronic apparatus 100 is played on the screen of the display device 300 in the memory of the display device 300 using the block chain method.

In operation S590, the electronic apparatus 100 may identify the reputations of the external terminal 200 and the display device 300 according to the advertisement playback history of the display device 300 stored in the block chain, which is the P2P based distributed database, and store the identified reputations in the memory of the electronic apparatus 100 using the block chain method.

Therefore, the electronic apparatus 100 may confirm whether or not the advertisement is played on the display device 300 according to the contract condition using the above-mentioned method. In a case in which the advertisement is not played on the display device 300 according to the contract condition, the electronic apparatus 100 may evaluate the reputation of the external terminal 200, and store the evaluated reputation in the memory of the electronic apparatus 100 using the block chain method.

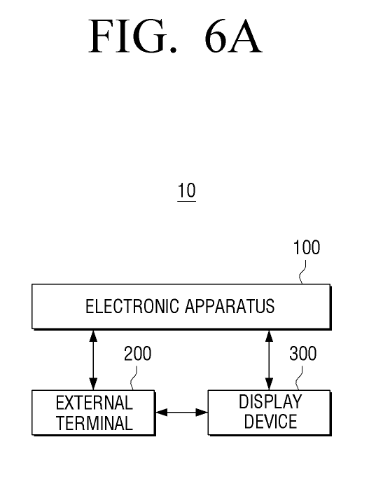

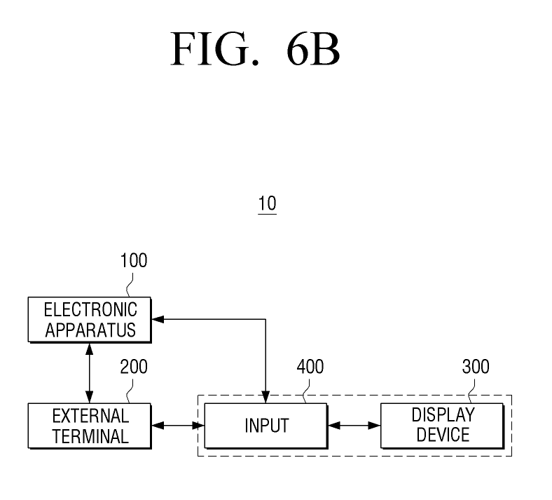

FIGS. 6A and 6B are block diagrams configuring a block chain based distributed open advertisement market system according to various embodiments of the present disclosure.

Referring to FIG. 6A, the system 10 includes the electronic apparatus 100, the external terminal 200, and the display device 300.

As described above in FIGS. 1 to 5, the electronic apparatus 100 may provide the advertisement information to the display device 300, and the external terminal 200 may control the display device 300 to play the advertisement provided by the electronic apparatus 100 on the screen of the display device 300. The electronic apparatus 100 may perform the transaction with the external terminal 200, and the performed transactional history may be stored in the memory of each of the electronic apparatus 100 and the external terminal 200 using the block chain method.

Referring to FIG. 6B, the system 10 includes the electronic apparatus 100, the external terminal 200, the display device 300, and an input device 400.

Unlike FIG. 6A, the electronic apparatus 100 may provide the advertisement information to the input device 400, and the external terminal 200 may control the display device 300 through the input device 400 to play the advertisement provided by the electronic apparatus 100 on the screen of the display device 300.

That is, in the block diagram illustrated in FIG. 6B, the display device 300 may not include software for the block chain based open advertisement system described in the present disclosure, and the input device 400 may include the software for the block chain based open advertisement system.

For example, the methods included in the display device 300 described above in FIGS. 1 to 5 of the present disclosure may be implemented in software in the input device 400, and the methods described above in the present disclosure may be implemented by connecting the input device 400 to the display device 300 of the FIG. 6B through an input terminal such as a high-definition multimedia interface (HDMI) terminal or the like. The input device 400 may be an external device which may be connected to an input port of the display device 300, such as a universal serial bus (USB) port or the like, but is not limited thereto.

Therefore, although the various embodiments according to the present disclosure are not implemented in the display device 300 of the related art, they are implemented in the input device 400 compatible with the display device 300, thereby making it possible to use the display device 300 in the block chain based open advertisement system of the related art.

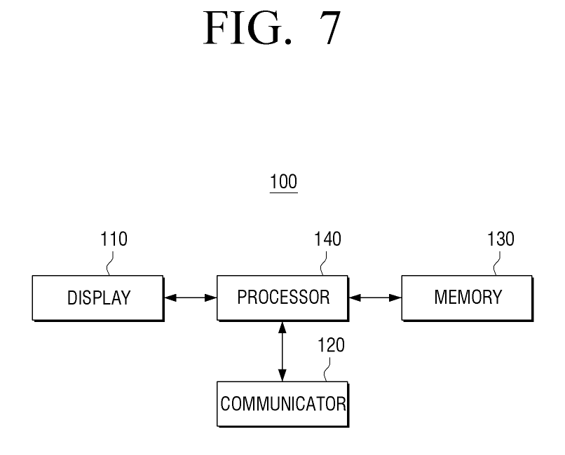

FIG. 7 is a block diagram of an electronic apparatus configuring a block chain based distributed open advertisement market system according to an embodiment of the present disclosure.

Referring to FIG. 7, the electronic apparatus 100 may include a display 110, a communicator 120, a memory 130, and a processor 140.

The electronic apparatus 100 may be a smartphone, a tablet computer, a desktop computer, a wearable device, or the like, but is not limited thereto.

The display 110 may visually display a variety of information, such as a liquid crystal display (LCD), an organic light emitting diode (OLED), or the like and may include a touch screen.

The communicator 120 may include a network interface (e.g., a transceiver) capable of performing wired and/or wireless communication. For example, the communicator 120 may include a network interface device such as Bluetooth, near field communication (NFC), or the like. The communicator 120 may include cellular communication technologies such as 3G, 4G, long-term evolution (LTE), code-division multiple access (CDMA), and the like. The communicator 120 may use the P2P network.

The memory 130 may include a storage device such as a random access memory (RAM), a flash memory, or a hard disk. The memory 130 may include a separate module capable of storing the transactional history and the advertisement information performed in the electronic apparatus 100 using the block chain method.

The processor 140 may receive information on the external display devices controlled by each of the plurality of external terminals from the plurality of external terminals through the communicator 120, identify at least one usable external display device among the external display devices based on the information of the external display devices and the reputation information on the plurality of external terminals, and transmit the advertisement information to at least one external display device through the communicator 120.

The reputation information on the plurality of external terminals, which is information identified depending on whether or not the plurality of terminals connected to each other through the wireless network perform the advertisement playback in the plurality of external display devices, may be stored in the memories of the plurality of terminals using the block chain method.

The processor 140 may identify the reputation of at least one external display device depending on whether or not at least one external display device performs the advertisement playback, and store the reputation information of at least one external display device in the memory 130 using the block chain method.

The advertisement information may include a kind of advertisement, an advertisement playback time, a desired usage price according to the advertisement playback, a transactional history according to the advertisement playback, and the like, and the transactional history may include a payment history for the usage of at least one external display device by the electronic apparatus 100. The kind of advertisement, the advertisement playback time, the desired usage price according to the advertisement playback, and the like may be contract conditions provided to the external terminal by the electronic apparatus 100, but the contract conditions are not limited thereto.

The information on the external display devices may include position information, an available time, a kind of transaction, price information according to the usage of the external display devices, and may be the contract condition of the external terminal set by the external terminal.

The processor 140 may identify at least one external display device which is positioned within a designated range from the electronic apparatus 100 using near field communication.

The processor 140 of the electronic apparatus 100 may perform the methods of the electronic apparatus 100 described above in FIGS. 2 and 5.

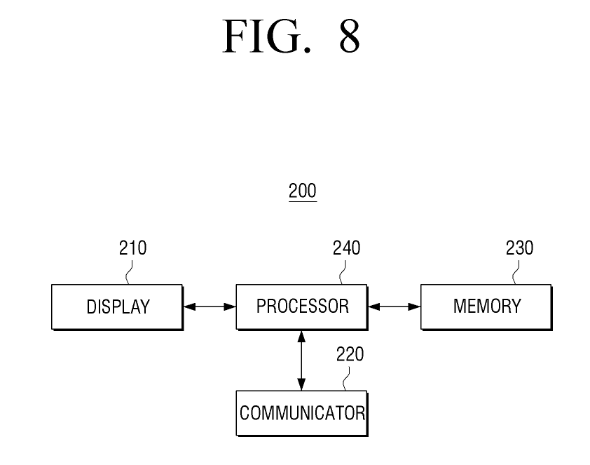

FIG. 8 is a block diagram of an external terminal configuring a block chain based distributed open advertisement market system according to an embodiment of the present disclosure.

Referring to FIG. 8, the external terminal 200 may include a display 210, a communicator 220, a memory 230, and a processor 240.

The external terminal 200 may be various devices such as a smartphone, a tablet computer, a desktop computer, a wearable device, or the like, but is not limited thereto. The external terminal 200 may remotely control the external display device 300.

Since the display 210, the communicator 220, and the memory 230 have the configurations and functions similar to the display 110, the communicator 120, and the memory 130 described above in FIG. 7, a detailed description thereof will be omitted.

The processor 240 may identify the reputation of the electronic apparatus 100 based on the advertisement information received from the electronic apparatus 100 through the communicator 220, and control the external display device 300 to play the advertisement on the external display device 300 according to the reputation of the electronic apparatus 100.

The processor 240 may store the reputation of the electronic apparatus 100 in the memory 230 using the block chain method.

The processor 240 may identify the reputation of the electronic apparatus using the payment history of the electronic apparatus 100 stored in the block chain, which is the distributed database, and store the reputation of the electronic apparatus 100 in the memory 230 using the block chain method.

The processor 240 may control the external display device 300 to change and play a playback state of the advertisement transmitted by the electronic apparatus 100 on the external display device 300 depending on the reputation of the electronic apparatus 100.

In a case in which the payment is not executed in the payment history of the electronic apparatus 100, the processor 240 may control the external display device 300 so as not to play the advertisement on the external display device 300.

The processor 240 of the external terminal 200 may perform the methods of the external terminal 200 described above in FIGS. 3 and 5.

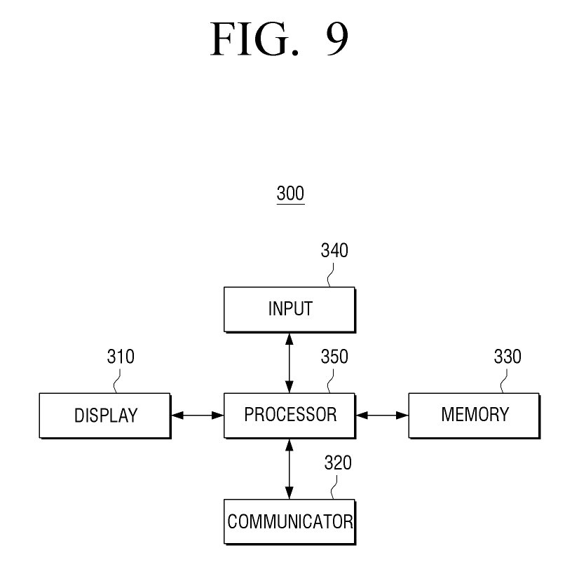

FIG. 9 is a block diagram of a display device configuring a block chain based distributed open advertisement market system according to an embodiment of the present disclosure.

Referring to FIG. 9, the display device 300 may include a display 310, a communicator 320, a memory 330, an input 340, and a processor 350.

Since the display 310, the communicator 320, and the memory 330 have the configurations and functions similar to the display 110, the communicator 120, and the memory 130 described above in FIG. 7, a detailed description thereof will be omitted.

The input 340 may include an input interface capable of connecting various input devices to the display device 300 through various kinds of peripheral buses. For example, the peripheral buses may be a peripheral component interconnect (PCI) bus standard, a USB standard, an HDMI standard, or the like, but is not limited thereto.

The processor 350 may transmit usage state information of the display 310 to the external terminal 200 through the communicator 320.

The processor 350 may receive the advertisement information from the electronic apparatus 100 through the communicator 320.

The processor 350 may identify the transactional history by confirming the payment histories of the external terminal 200 and the electronic apparatus 100 stored in the block chain.

The processor 350 may control the display 310 to play the advertisement information transmitted by the electronic apparatus 100 depending on the screen usage information set by the external terminal 200.

The processor 350 may store the advertisement playback history on the display 310 in the memory 330 using the block chain method.

The processor 350 of the display device 300 may perform the method of the display device 300 described above in FIG. 5.

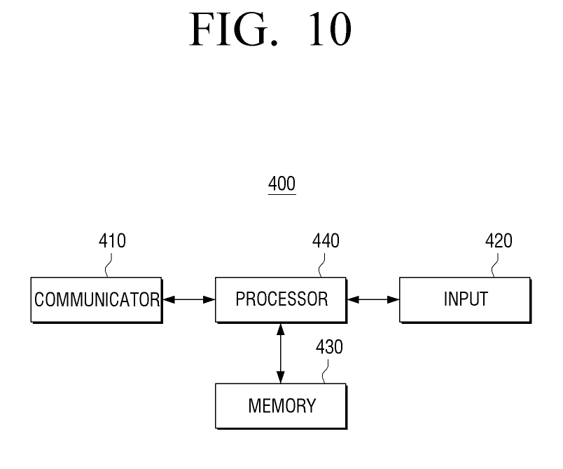

FIG. 10 is a block diagram of an input device connected to a display device according to an embodiment of the present disclosure.

Referring to FIG. 10, the input device 400 may include a communicator 410, an input 420, a memory 430, and a processor 440.

The input device 400 may be connected to the display device 300 from the outside of the display device 300. For example, the input device 400 may be a USB, but is not limited thereto. Since the communicator 410 and the memory 430 have the configurations similar to the communicator 320 and the memory 330 described above in FIG. 9, a detailed description thereof will be omitted.

Since the input 420 has the same configuration as the input 340 described above in FIG. 9, a detailed description thereof will be omitted.

The processor 440 may transmit usage state information of the display 310 of the display device 300 described above in FIG. 9 to the external terminal 200 through the communicator 410.

The processor 440 may receive the advertisement information from the electronic apparatus 100 through the communicator 410.

The processor 440 may identify the transactional history by confirming the payment histories of the external terminal 200 and the electronic apparatus 100 stored in the block chain.

The processor 440 may control the display 310 to play the advertisement information transmitted by the electronic apparatus 100 on the display device 300 depending on the screen usage information of the display device 300 set by the external terminal 200.

Further, the processor 440 may transmit setting information of the display device 300 received from the external terminal 200 to the display device 300 to play the advertisement information transmitted by the electronic apparatus 100 on the display device 300 depending on the screen usage information of the display device 300 set by the external terminal 200. In this case, the display device 300 may control the display 310 to play the advertisement on the display 310 based on the received setting information.

The processor 440 may store the advertisement playback history on the display 310 of the display device 300 in the memory 430 using the block chain method.

The processor 440 of the input device 400 may perform the method of the display device 300 described above in FIG. 5.

The methods according to an embodiment of the present disclosure may be implemented in a program instruction type that may be performed through various computer means and may be recorded in a computer-readable medium. The computer-readable medium may include program instructions, data files, data structure, or the like, alone or a combination thereof. For example, the computer-readable medium may be stored in a volatile or non-volatile storage apparatus such as a storage device of read-only memory (ROM) or the like, or for example, a memory such as RAM, a memory chip, an apparatus or an integrated circuit (IC), or for example, an optically or magnetically recordable and machine (e.g., a computer) readable storage medium such as a compact disc (CD), a digital versatile disc (DVD), a magnetic disk, a magnetic tape, or the like, irrespective of whether or not it is removable or rewritable.

It may be understood that the memory which may be included in the electronic apparatus 100, the external terminal 200, the display device 300, and the input device 300 is an example of a machine-readable storage medium suitable for storing a program or programs including the instructions implementing the various embodiments of the present disclosure. The program instruction recorded in the storage medium may be designed and constituted especially for the present disclosure, or may also be known to those skilled in a field of computer software to be used.

As described above, the present disclosure has been described with reference to the various embodiments and the drawings. The present disclosure is not limited to the above-mentioned various embodiments, and various modifications and changes may be made by those skilled in the art to which the present disclosure pertains from the above-mentioned description without departing from the spirit of the present disclosure.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for controlling an electronic apparatus, the controlling method comprising:
receiving device information related to external display devices from a plurality of external terminals through a wireless network, wherein each external display device is controlled by a corresponding external terminal;
identifying a first external display device among the external display devices based on the device information and reputation information associated with each of the plurality of external terminals; and
transmitting advertisement information to a first external terminal associated with the first external display.

2. The method of claim 1, wherein the wireless network is a peer to peer (P2P) network.

3. The method of claim 2,
wherein the plurality of external terminals are connected to each other through the P2P network, and
wherein the reputation information is stored in a block chain and is determined based on whether the plurality of external display devices perform an advertisement playback.

4. The method of claim 3, further comprising:
identifying first reputation information of the first external display device based on whether the first external display device performs the advertisement playback; and
storing the first reputation information in a block chain.

5. The method of claim 1,
wherein the advertisement information includes a type of an advertisement, an advertisement playback time, payment information according to an advertisement playback, and a transactional history, and
wherein the transactional history includes a payment history for usage of the first external display device by the electronic apparatus.

6. The method of claim 5, further comprising receiving a playback notification from the first external terminal, the playback notification indicating that the advertisement was played on the first external display device,
wherein the first external display device stores a reputation of the electronic apparatus based on payment history.

7. The method of claim 1,
wherein the device information is set by each external terminal, and
wherein the device information includes position information, an available time, a type of transaction, and price information according to usage of the external display device.

8. The method of claim 1, wherein the identifying of the first external display device comprises determining whether the first external display device is positioned within a designated range from the electronic apparatus using near field communication.

9. An electronic apparatus comprising:
a transceiver configured to communicate through a wireless network;
a memory; and
a processor configured to:
control the transceiver to receive device information related to external display devices from a plurality of external terminals, wherein each external display device is controlled by a corresponding external terminal,
identify a first external display device among the external display devices based on the device information and reputation information associated with each of the plurality of external terminals, and
control the transceiver to transmit advertisement information to a first external terminal associated with the first external display.

10. The electronic apparatus of claim 9, wherein the wireless network is a peer to peer (P2P) network.

11. The electronic apparatus of claim 10,
wherein the plurality of external terminals are connected to each other through the P2P network, and
wherein the reputation information is stored in a block chain and is determined based on whether the plurality of external display devices perform an advertisement playback.

12. The electronic apparatus of claim 11, wherein the processor is further configured to:
identify first reputation information of the first external display device based on whether the first external display device performs the advertisement playback, and
store the first reputation information in a block chain.

13. The electronic apparatus of claim 9,
wherein the advertisement information includes a type of an advertisement, an advertisement playback time, payment information according to an advertisement playback, and a transactional history, and
wherein the transactional history includes a payment history for usage of the first external display device by the electronic apparatus.

14. The electronic apparatus of claim 9,
wherein the device information is set by each external terminal, and
wherein the device information includes position information, an available time, a type of transaction, and price information according to usage of the external display device.

15. The electronic apparatus of claim 9, wherein the processor is further configured to determine whether the first external display device is positioned within a designated range from the electronic apparatus using near field communication.

16. An external terminal comprising:
a transceiver configured to communicate through a wireless network;
a memory; and
a processor configured to:
control the transceiver to receive advertisement information,
identify a reputation of an electronic apparatus based on the advertisement information, and
control an external display device to play an advertisement based on the reputation of the electronic apparatus.

17. The external terminal of claim 16,
wherein the wireless network is a peer to peer (P2P) network, and
wherein the reputation of the electronic apparatus is stored in a block chain.

18. The external terminal of claim 16, wherein the processor is further configured to:
determine the reputation of the electronic apparatus using a payment history of the electronic apparatus that is stored in a block chain, and
store the reputation of the electronic apparatus in the block chain.

19. The external terminal of claim 16, wherein the processor is further configured to control the transceiver to transmit an advertisement for playback on the external display device based on the reputation of the electronic apparatus.

20. The external terminal of claim 19, wherein the processor is further configured to, when a payment is not executed in a payment history of another external display device, determine that the other external display is not a candidate to play the advertisement.
